(19) United States
(12) Patent Application Publication
(10) Pub. No.: US 2005/0174439 A1
(43) Pub. Date: Aug. 11, 2005

(54) Imaging method and image reproducing method

(76) Inventor: Katsumi Komagamine, Kagoshima-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/029,939

(22) Filed: Jan. 4, 2005

(30) Foreign Application Priority Data
Jan. 5, 2004 (JP) 2004-000512

(51) Int. Cl. H04N 5/228

(52) U.S. Cl. 348/222.1

(57) ABSTRACT

An imaging method including the steps of: imaging a subject at a specific latitude to generate original image data of a first number of gradations; generating, on the basis of the original image data, primary image data representing the subject at a second number of gradations fewer than the first number of gradations in regard to a first light quantity range narrower than the latitude; generating, on the basis of the original image data, secondary image data representing the subject in regard to a second light quantity range including a light quantity range where the gradations are saturated by the primary image data; and associating and saving the primary image data and the secondary image data.

### CROSS-REFERENCE TO RELATED APPLICATIONS

The disclosure of Japanese Patent Application No. 2004-000512 filed on Jan. 5, 2004, including the specification, drawings and abstract, is incorporated herein by reference in its entirety.

### BACKGROUND OF THE INVENTION

1. Field of the Invention

The present invention relates to an imaging method and an image reproducing method.

2. Description of the Related Art

The number of gradations of image data outputted by an imaging device such as a digital still camera (DSC) differs depending on the latitude of the imaging unit with which the imaging device is disposed. Here, “latitude” refers to exposure latitude and is expressed by a range of exposure such as −5 EV to +5 EV. When the light quantity exceeds the latitude, white saturation occurs in which the bright portions of the subject become white, and when the light quantity is less than the latitude, black saturation occurs in which the dark portions of the subject become black. Thus, latitude can also be defined as something where the contrast expressible by the imaging unit is represented by the range of exposure. The wider the latitude is, the wider the expressible contrast becomes. Thus, it is preferable to increase the number of gradations of the image data to be outputted. Here, “number of gradations” refers to the range of expressible gradation values. For example, when a gradation value is expressed by 8 bits, 256 gradations of 0 to 255 can be expressed, so that the number of gradations in this case is 256.

However, when image data where the number of gradations is large are outputted by an imaging unit whose latitude is wide, there is the problem that the image data cannot be reproduced depending on the reproducing unit. For example, let us assume that image data where the number of gradations is 512 are to be outputted and that the number of gradations displayable by a monitor of the imaging unit is 256. In this case, the monitor cannot display the image data. If image data where the number of gradations is small are outputted in accommodation with the monitor, the image data can be displayed on the monitor. However, when the number of gradations printable by a printer is greater than that of the monitor, the printing capability of the printer cannot be utilized to its fullest when the image data are outputted in accommodation with the monitor. Also, with respect to retouching the image data, the image quality cannot be finely controlled because the range of reproducible colors becomes narrow when the number of gradations of the image data is small.

When image data have been outputted by an imaging unit whose latitude is narrow, it becomes easy for white saturation and black saturation to occur because the exposure latitude is narrow. For this reason, it becomes easy for failed imaging resulting from failure in adjusting the exposure to occur. As a method for improving the latitude of the imaging unit, a method is known where image data are outputted at mutually different plural exposures when a shutter button is depressed, and the outputted plural sets of image data are synthesized to generate a single set of image data. According to this method, image data where the number of gradations is large can be generated with an imaging device whose latitude is narrow. Thus, it becomes difficult for white saturation and black saturation to occur, and failed imaging can be reduced. However, although failed imaging can be relieved with this method because image data are generated where the number of gradations is large, the problem remains that the image data cannot be reproduced with a reproducing device whose number of reproducible gradations is small.

It is also possible to reproduce the plural sets of image data on a monitor by outputting the plural sets of image data without synthesizing those sets of image data, but this is not very convenient because it is necessary to use a personal computer or the like to synthesize the image data when retouching the image data. Also, because the spread of imaging devices with wider latitudes is to be expected in the future, a situation can be expected where reproducing devices whose number of reproducible gradations is small cannot reproduce the image data even though the image data have not been synthesized.

### SUMMARY OF THE INVENTION

The present invention has been created in view of this problem, and it is an object thereof to provide an imaging device, an imaging method and a program that enable the generation of image data reproducible even with a reproducing device whose number of reproducible gradations is small and the relief of image data for which there was a failure in adjusting the exposure.

It is another object of the invention to provide an image reproducing method, an image reproducing device and a program that relieve and reproduce image data for which there was a failure in adjusting the exposure.

It is still another object of the invention to provide an image processing method that generates image data reproducible even with a reproducing device whose number of reproducible gradations is small and relieves image data for which there was a failure in adjusting the exposure.

(1) For solving the above problems, an imaging method comprising the steps of: imaging a subject at a specific latitude to generate original image data of a first number of gradations; generating, on the basis of the original image data, primary image data representing the subject at a second number of gradations fewer than the first number of gradations in regard to a first light quantity range narrower than the latitude; generating, on the basis of the original image data, secondary image data representing the subject in regard to a second light quantity range including a light quantity range where the gradations are saturated by the primary image data; and associating and saving the primary image data and the secondary image data.

According to this invention, original image data representing the subject at a number of gradations fewer than those of the original image are generated and saved in regard to a light quantity range narrower than the latitude at the time of imaging. Thus, image data that can be reproduced even with a reproducing device whose number of reproducible gradations is small can be saved. Also, according to this invention, a secondary image representing the subject in regard to a second light quantity range including a light quantity range where the gradations are saturated by the primary image data is saved. For this reason, it becomes possible to supplement, with the secondary image data, places in the primary image data where white saturation and black saturation have occurred. Thus, according to this invention, image data that can be reproduced even with a reproducing device whose number of reproducible gradations is small and with which relief of a failed image is possible can be saved.

(2) For solving the above problems, an imaging method comprising the steps of: imaging a subject plural times at mutually different latitudes in accordance with a one-time imaging instruction to generate plural sets of original image data of a first number of gradations; generating, on the basis of one of the plural sets of original image data outputted by the imaging step, primary image data representing the subject in regard to a first light quantity range; generating, on the basis of another one of the plural sets of original image data, secondary image data representing the subject in regard to a second light quantity range including a light quantity range where the gradations are saturated by the primary image data; and associating and saving the primary image data and the secondary image data.

According to this invention, a secondary image representing the subject in regard to a second light quantity range including a light quantity range where the gradations are saturated by the primary image data is saved. Thus, it becomes possible to supplement, with the secondary image data, places in the primary image data where white saturation and black saturation have occurred. Thus, according to this invention, reproduction with a reproducing device whose number of reproducible gradations is small and relief of failed imaging can both be achieved, even when the contrast of the subject is high or when the latitude of the imaging unit is narrow.

(3) In the saving step, the primary image data and the secondary image data may be saved in different regions of a same file.

According to this invention, the primary image data and the secondary image data are saved in the same file. Thus, it becomes easy to handle the secondary image data necessary for relieving a failed image.

(4) In the step of generating the secondary image data, the lowest number of bits necessary for expressing the maximum gradation value of the secondary image data may be determined, and the gradation values of the secondary image data may be expressed by the determined number of bits.

According to this invention, the data amount of the secondary image data can be reduced.

(5) In the step of generating the primary image data, the generated primary image data may have gradation values of a luminance component and a color difference component per pixel. In the step of generating the secondary image data, the generated secondary image data may have gradation values of only a luminance component per pixel.

According to this invention, the data amount of the secondary image data can be reduced.

(6) In the saving step, information representing the first light quantity range may be associated and stored with the primary image data, and information representing the second light quantity range may be associated and stored with the secondary image data.

According to this invention, the light quantity ranges corresponding to the primary image data and the secondary image data can be specified. Thus, when the primary image data and the secondary image data are synthesized, the hierarchy of the light quantity ranges corresponding to the primary image data and the secondary image data can be specified. For example, according to this invention, the mistake can be prevented where the secondary image data representing the subject in regard to the side where the light quantity range is high from the primary image is used as the secondary image representing the subject in regard to the side where the light quantity range is low at the time of synthesis.

(7) In the saving step, the secondary image data may be stored only when there are pixels where the gradations are saturated by the primary image data.

According to this invention, the storage capacity necessary for saving image data representing one subject can be reduced.

(8) For solving the above problems, an imaging device comprising: an imaging unit for imaging a subject at a specific latitude to generate original image data of a first number of gradations; a primary image data generating unit for generating, on the basis of the original image data, primary image data representing the subject at a second number of gradations fewer than the first number of gradations in regard to a first light quantity range narrower than the latitude; a secondary image data generating unit for generating, on the basis of the original image data, secondary image data representing the subject in regard to a second light quantity range including a light quantity range where the gradations are saturated by the primary image data; and a saving unit for associating and saving the primary image data and the secondary image data.

According to this invention, original image data representing the subject at a number of gradations fewer than those of the original image are generated and saved in regard to a light quantity range narrower than the latitude at the time of imaging. For this reason, image data that can be reproduced even with a reproducing device whose number of reproducible gradations is small can be saved. Also, according to this invention, secondary image data representing the subject in regard to a second light quantity range including a light quantity range where the gradations are saturated by the primary image data are saved. For this reason, it becomes possible to supplement, with the secondary image data, places in the primary image data where white saturation and black saturation have occurred. Thus, according to this invention, image data that can be reproduced even with a reproducing device whose number of reproducible gradations is small and with which relief of a failed image is possible can be saved.

(9) For solving the above problems, a computer-readable storage medium stores a program causing a digital camera to function as: an imaging unit for imaging a subject at a specific latitude to generate original image data of a first number of gradations; a primary image data generating unit for generating, on the basis of the original image data, primary image data representing the subject at a second number of gradations fewer than the first number of gradations in regard to a first light quantity range narrower than the latitude; a secondary image data generating unit for generating, on the basis of the original image data, secondary image data representing the subject in regard to a second light quantity range including a light quantity range where the gradations are saturated by the primary image data; and a saving unit for associating and saving the primary image data and the secondary image data.

According to this invention, original image data representing the subject at a number of gradations fewer than those of the original image are generated and saved in regard to a light quantity range narrower than the latitude at the time of imaging. For this reason, image data that can be reproduced even with a reproducing device whose number of reproducible gradations is small can be saved. Also, according to this invention, secondary image data representing the subject in regard to a second light quantity range including a light quantity range where the gradations are saturated by the primary image data are saved. For this reason, it becomes possible to supplement, with the secondary image data, places in the primary image data where white saturation and black saturation have occurred. Thus, according to this invention, image data that can be reproduced even with a reproducing device whose number of reproducible gradations is small and with which relief of a failed image is possible can be saved.

(10) For solving the above problems, an imaging device for achieving the aforementioned objects comprising: an imaging unit for imaging a subject plural times at mutually different latitudes in accordance with a one-time imaging instruction to generate plural sets of original image data of a first number of gradations; a primary image data generating unit for generating, on the basis of one of the plural sets of original image data outputted from the imaging unit, primary image data representing the subject in regard to a first light quantity range; a secondary image data generating unit for generating, on the basis of another one of the plural sets of original image data, secondary image data representing the subject in regard to a second light quantity range including a light quantity range where the gradations are saturated by the primary image data; and a saving unit for associating and saving the primary image data and the secondary image data.

According to this invention, a secondary image representing the subject in regard to a second light quantity range including a light quantity range where the gradations are saturated by the primary image data is saved. Thus, it becomes possible to supplement, with the secondary image data, places in the primary image data where white saturation and black saturation have occurred. Thus, according to this invention, reproduction with a reproducing device whose number of reproducible gradations is small and relief of failed imaging can both be achieved, even when the contrast of the subject is high or when the latitude of the imaging unit is narrow.

(11) For solving the above problems, a computer-readable storage medium stores a program for causing a digital camera to function as: an imaging unit for imaging a subject plural times at mutually different latitudes in accordance with a one-time imaging instruction to generate plural sets of original image data of a first number of gradations; a primary image data generating unit for generating, on the basis of one of the plural sets of original image data outputted from the imaging unit, primary image data representing the subject in regard to a first light quantity range; a secondary image data generating unit for generating, on the basis of another one of the plural sets of original image data, secondary image data representing the subject in regard to a second light quantity range including a light quantity range where the gradations are saturated by the primary image data; and a saving unit for associating and saving the primary image data and the secondary image data.

According to this invention, a secondary image representing the subject in regard to a second light quantity range including a light quantity range where the gradations are saturated by the primary image data is saved. Thus, it becomes possible to supplement, with the secondary image data, places in the primary image data where white saturation and black saturation have occurred. Thus, according to this invention, reproduction with a reproducing device whose number of reproducible gradations is small and relief of failed imaging can both be achieved, even when the contrast of the subject is high or when the latitude of the imaging unit is narrow.

(12) For solving the above problems, an image reproducing method comprising the steps of: synthesizing primary image data representing a subject in regard to a first light quantity range and secondary image data representing the subject in regard to a second light quantity range including a light quantity range where the gradations are saturated by the primary image data, to thereby generate composite image data representing the subject in regard to a light quantity range including the first light quantity range and the second light quantity range; and reproducing the composite image data.

According to this invention, a digital image where failure to adjust the exposure is relieved can be reproduced by synthesizing the primary image data and the secondary image data to generate composite image data with a large number of gradations.

(13) The image reproducing method may further include the step of handling the selection of the primary image data or the composite image data. In the reproducing step, one of the composite image data and the primary image data selected in the selection handling step may be reproduced.

According to this invention, the user can select which of the composite image data and the primary image data to reproduce.

(14) The image reproducing method may further include the step of selecting a gradation range of the composite image data. In the reproducing step, the composite image data may be reproduced in regard to the gradation range selected in the gradation range selecting step.

According to this invention, the user can select how to relieve the digital image for which there was a failure to adjust the exposure.

(15) In the reproducing step, the gradation values of the composite image data may be extended or compressed in accordance with the number of reproducible gradations.

According to this invention, the burden of selecting a gradation range for determining the gradation values to be reproduced can be reduced.

(16) The image reproducing method may further include the step of notifying a user that underexposure or overexposure can be compensated on the basis of the secondary image data.

According to this invention, the user can be notified that underexposure or overexposure can be compensated, i.e., that the digital image can be relieved.

(17) For solving the above problems, an image reproducing device comprising: an image data synthesizing unit for synthesizing primary image data representing a subject in regard to a first light quantity range and secondary image data representing the subject in regard to a second light quantity range including a light quantity range where the gradations are saturated by the primary image data, to thereby generate composite image data representing the subject in regard to a light quantity range including the first light quantity range and the second light quantity range; and a reproducing unit for reproducing the composite image data.

According to this invention, a digital image where failure to adjust the exposure is relieved can be reproduced by synthesizing the primary image data and the secondary image data to generate composite image data with a large number of gradations.

(18) For solving the above problems, a computer-readable storage medium stores a program for causing a computer to act as: an image data synthesizing unit for synthesizing primary image data representing a subject in regard to a first light quantity range and secondary image data representing the subject in regard to a second light quantity range including a light quantity range whose gradations are saturated by the primary image data, to thereby generate composite image data representing the subject in regard to a light quantity range including the first light quantity range and the second light quantity range; and a reproducing unit for reproducing the composite image data.

According to this invention, a digital image where failure to adjust the exposure is relieved can be reproduced by synthesizing the primary image data and the secondary image data to generate composite image data with a large number of gradations.

(19) For solving the above problems, an image processing method comprising the steps of: imaging a subject at a specific latitude with an imaging unit to generate original image data of a first number of gradations; generating, on the basis of the original image data, primary image data representing the subject at a second number of gradations fewer than the first number of gradations in regard to a first light quantity range narrower than the latitude; generating, on the basis of the original image data, secondary image data representing the subject in regard to a second light quantity range including a light quantity range where the gradations are saturated by the primary image data; associating and saving the primary image data and the secondary image data; synthesizing the primary image data and the secondary image data to thereby generate composite image data representing the subject in regard to a light quantity range including the first light quantity range and the second light quantity range; and reproducing the composite image data.

According to this invention, image data that can be reproduced even with a reproducing device whose number of reproducible gradations is small and in which a failed image is relieved can be reproduced.

(20) For solving the above problems, an image processing method comprising the steps of: imaging a subject plural times at mutually different latitudes in accordance with a one-time imaging instruction to generate plural sets of original image data of a first number of gradations; generating, on the basis of one of the plural sets of original image data outputted by the imaging step, primary image data representing the subject in regard to a first light quantity range; generating, on the basis of another one of the plural sets of original image data, secondary image data representing the subject in regard to a second light quantity range including a light quantity range where the gradations are saturated by the primary image data; associating and saving the primary image data and the secondary image data; synthesizing the primary image data and the secondary image data to thereby generate composite image data representing the subject in regard to a light quantity range including the first light quantity range and the second light quantity range; and reproducing the composite image data.

According to this invention, image data that can be reproduced even with a reproducing device whose number of reproducible gradations is small and in which a failed image is relieved can be reproduced.

In addition, each function of a plurality of the units provided for according to the foregoing embodiments of the invention is may be implemented by hardware resources such that the functions are specified by the hardware configuration itself, or hardware resources such that the functions are specified by software programs, or the combinations thereof. Furthermore, each function of the plurality of the various functions of the different units described is are not limited to those being implemented by hardware resources physically independent of each one another.

The present invention can be specified not only as inventions of devices and methods, but also as inventions of programs and inventions of storage media in which those programs are stored.

The above and other objects, effects, features and advantages of the present invention will become more apparent from the following description of embodiments thereof taken in conjunction with the accompanying drawings.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is a schematic diagram showing primary image data and secondary image data pertaining to a first embodiment of the invention;

FIG. 2 is a block diagram of an image data reproducing system pertaining to the first embodiment of the invention;

FIG. 3 is a block diagram of an image storing program pertaining to the first embodiment of the invention;

FIGS. 4A and 4B are schematic diagrams for describing compression pertaining to the first embodiment of the invention;

FIG. 5 is a schematic diagram showing a file structure pertaining to the first embodiment of the invention;

FIG. 6 is a flow chart pertaining to the first embodiment of the invention;

FIG. 7 is a block diagram of an image data reproducing program pertaining to the first embodiment of the invention;

FIG. 8 is a schematic diagram showing a dialog pertaining to the first embodiment of the invention;

FIG. 9 is a schematic diagram showing a dialog pertaining to the first embodiment of the invention;

FIGS. 10A and 10B are schematic diagrams showing the selection of a gradation range pertaining to the first embodiment of the invention;

FIGS. 11A to 11C are schematic diagrams showing the relief of failed imaging pertaining to the first embodiment of the invention;

FIG. 12 is a flow chart pertaining to the first embodiment of the invention;

FIG. 13 is a schematic diagram showing an image data reproducing system pertaining to a second embodiment of the invention;

FIG. 14 is a block diagram of an image data reproducing program pertaining to the second embodiment of the invention;

FIG. 15 is a flow chart pertaining to the second embodiment of the invention; and

FIG. 16 is a schematic diagram showing primary image data and secondary image data pertaining to a third embodiment of the invention.

### DETAILED DESCRIPTION OF THE INVENTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

### First Embodiment

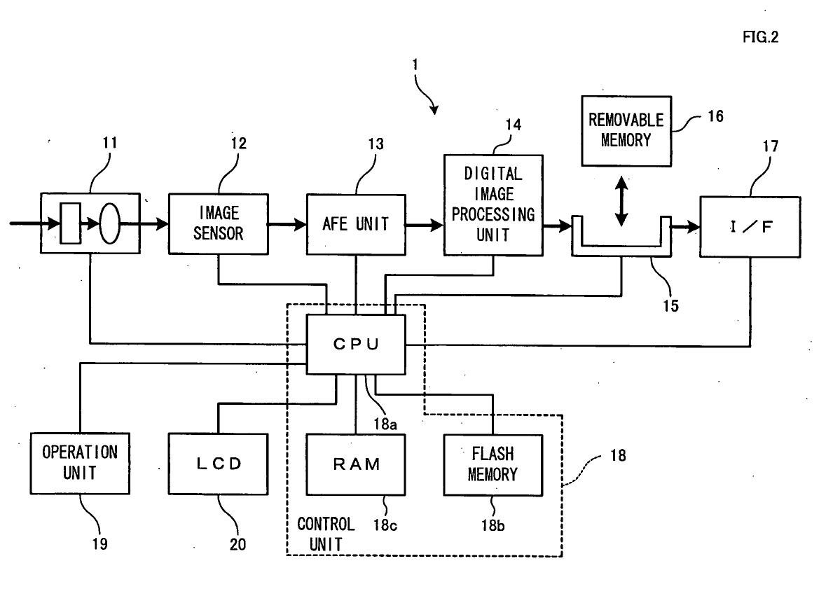

FIG. 2 is a block diagram showing the hardware configuration of a digital still camera (DSC) 1 serving as an imaging device and an image data reproducing device pertaining to a first embodiment of the invention. A liquid crystal display (LCD) 20 serving as a reproducing unit is integrated in the DSC 1.

An imaging unit pertaining to the present embodiment is configured by an optical system 11, an image sensor 12, an analog front end (AFE) unit 13 and a digital image processing unit 14.

The optical system 11 is configured by a lens and an aperture. The optical system 11 causes an optical image of a subject to be imaged on a light-receiving surface of the image sensor 12.

The image sensor 12 is an area image sensor disposed with light-receiving cells discretely disposed in two-dimensional space and a charge-transfer device such as a charge-coupled device (CCD). The image sensor 12 accumulates, over a given period of time on each light-receiving cell, charges obtained by photoelectrically converting the optical image imaged by the optical system 11, and outputs electrical signals in accordance with the received light quantity of each light-receiving cell. Complementary color filters of the four colors of cyan (C), magenta (M), yellow (Y) and green (G), or primary color filters of red (R), green (G) and blue (B), are disposed on the light-receiving surface of the image sensor 12, whereby the image sensor 12 forms color image data.

The AFE unit 13 quantizes and converts, to digital signals, the electrical signals outputted from the image sensor 12. Specifically, for example, the AFE 13 conducts processing for reducing noise included in the outputted electrical signals, processing for adjusting the level of the electrical signals by adjusting the gain, and quantization.

The digital image processing unit 14 conducts processing for forming image data, white balance correction, γ correction and color-space conversion with respect to the digital signals outputted from the AFE 13, and outputs original image data represented by a color space comprising a luminance component and color difference component, i.e., the YCbCr color space. The digital image processing unit 14 may also output original image data represented by another color space such as the RGB color space. The number of gradations of the original image data is set in accordance with the latitude of the image sensor 12. In the present embodiment, the number of gradations is 512; namely, the digital image processing unit 14 outputs original image data where the gradation values are represented by 9 bits. The gradation range of the original image data in this case is 0 to 511.

The DSC 1 also includes a card reading/writing unit 15. The card reading/writing unit 15 serves as a saving unit and is disposed with a memory controller and a card slot for inserting a removable memory 16. The card reading/writing unit 15 is controlled by a control unit 18 and conducts processing for writing image data to the removable memory 16 and processing for reading image data from the removable memory 16. The removable memory 16 is a rewritable recording medium that can retain its recorded data even when the power is removed. The storage unit may be a built-in Flash Memory or RAM, or a removable recording medium such as a flexible disk or removable hard disk.

The DSC 1 also includes an interface (I/F) unit 17 that is configured in compliance with a communication standard such as Bluetooth or USB. The DSC1 is connected to a personal computer (PC) or a printer via the I/F unit 17.

The LCD 20 functions as an electronic viewfinder in an imaging mode, and also functions as a reproducing unit that reproduces image data in a reproducing mode. In addition, the LCD 20 also functions as a selection handling unit, a gradation range selecting unit and a notifying unit by displaying various kinds of dialogs. In the present embodiment, the number of gradations reproducible by the LCD 20 is 256 per component. In the color-displayable LCD 20, one pixel can reproduce 1,677,216 colors when the number of gradations of one component is 256, because one pixel is usually represented by the three components of R, G and B.

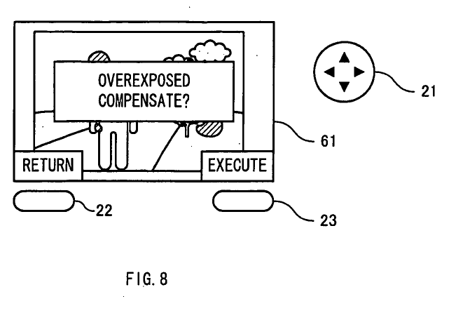

The DSC 1 also includes an operation unit 19. The operation unit 19 is disposed with a dial switch for setting the mode of the DSC 1, such as the imaging mode and the reproducing mode, in accordance with the rotation angle, a shutter button, an arrow key 21 (see FIG. 8) for operating various kinds of menus displayed on the LCD 20, and push buttons 22 and 23 (see FIG. 8) whose functions change in accordance with the menu display items.

The control unit 18 is disposed with a CPU 18a, a Flash Memory 18b and a RAM 18c. The CPU 18a controls the entire DSC 1 by executing a computer program stored in the Flash Memory 18b. The CPU 18a also functions as the imaging unit, a primary image data generating unit, a secondary image data generating unit and the saving unit by executing an image storing program stored in the Flash Memory 18b. Moreover, the CPU 18a also functions as an image data synthesizing unit, the reproducing unit, the selection handling unit, the gradation range selecting unit and the notifying unit by executing an image data reproducing program. The Flash Memory 18b is a memory that stores the image storing program, the image data reproducing program, and other various kinds of programs and data, and the RAM 18c is a memory that temporarily stores various kinds of programs and data. These various kinds of programs and data may be downloaded and inputted from a predetermined server via a network, or may be read and inputted from a computer-readable storage medium such as the removable memory 16.

Next, the logical configuration of the image storing program will be described.

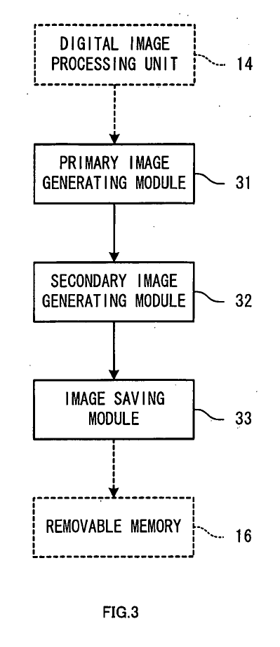

FIG. 3 is a block diagram showing the logical configuration of the image storing program. The image storing program is disposed with a primary image data generating module 31, a secondary image data generating module 32 and an image data saving module 33.

The primary image data generating module 31 is a module for executing processing for generating, on the basis of the original image data outputted from the digital image processing unit 14, primary image data representing a subject with a number of gradations fewer than that of the original image data. The gradation range of the primary image data corresponds to a light quantity range that is narrower than the latitude of the imaging unit configured by the image sensor 12 and the like. The primary image data represent information equivalent to the information of the subject that the image data generated by an imaging unit whose latitude is narrower than that of the imaging unit of the DSC 1 have. Specifically, the primary image data are generated in the following manner. Namely, an upper limit of the gradation range of the primary image data is allocated with respect to the gradation values of the original image data corresponding to light stronger than the light corresponding to the upper limit of the gradation range of the primary image data narrower than the gradation range of the original image data. A lower limit of the gradation range of the primary image data is allocated with respect to the gradation values of the original image data corresponding to light weaker than the light corresponding to the lower limit of the gradation range of the primary image data. Gradation values that have a linear relationship with the gradation values of the original image data are allocated with respect to the gradation values of the original image data corresponding to the intensity of the light corresponding to the gradation range of the primary image data.

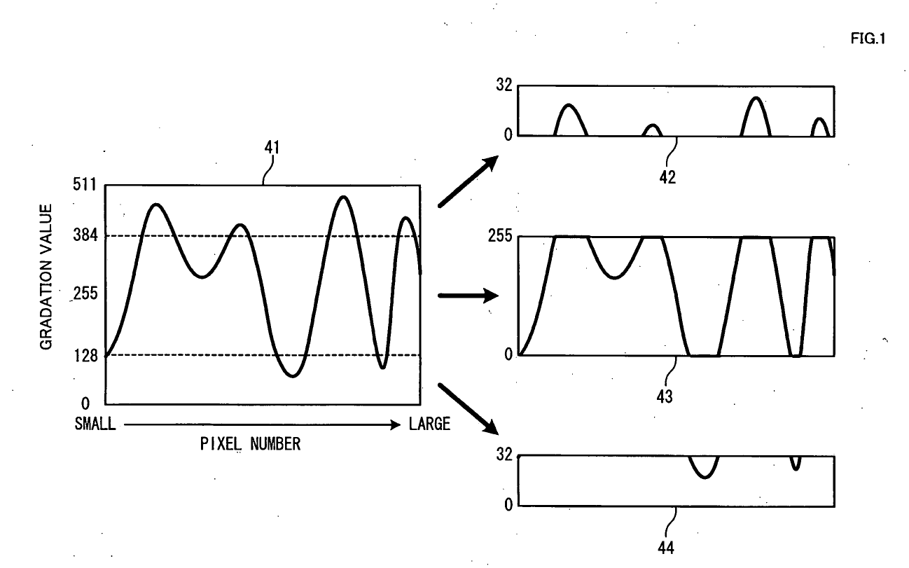

FIG. 1 is a schematic diagram for describing the generation of the primary image data by the primary image data generating module 31 and the generation of the secondary image data by the secondary image data generating module 32. Graph 41 in FIG. 1 shows the gradation values of the Y component of pixels configuring the outputted original image data, and graph 43 shows the gradation values of the Y component of pixels configuring the generated primary image data.

When the primary image data are generated, first, the gradation range (first gradation range) of the original image data linearly corresponding to the gradations of the primary image data is set. The first gradation range is set in accordance with the set exposure. Specifically, for example, when the exposure is specified, a standard gradation value of the original image data corresponding to the specified exposure is specified. The standard gradation value of the original image data corresponding to each exposure is determined in advance. The range equally centered around the standard gradation value corresponding to the exposure serves as the first gradation range. For example, let us assume that the standard gradation value of the original image data corresponding to a certain exposure is 255, and that the number of gradations of the primary image data is 256, which is consistent with the number of gradations reproducible by the LCD 20. In this case, the first gradation range is set so that 255 is the median and the difference between the upper limit and the lower limit is 256. Namely, the first gradation range is set to 128 to 384, and gradation values of 128 to 384 of the original image data are linearly corresponded to gradation values of 0 to 255 of the primary image data. It will be noted that the first gradation range may also be a fixed range.

When the first gradation range is set as described above, the primary image data generating module 31 substitutes, of the gradation values configuring the original image data, 384 for gradation values exceeding 384 and 128 for gradation values less than 128. The primary image data generating module 31 retains, as is, gradation values that are within the range of 128 to 384. When the purpose is to reproduce image data on an image data reproducing device other than the LCD 20, the number of first gradations may be the same as or smaller than the number of gradations of that image data reproducing device. Namely, the number of first gradations does not have to be invariably smaller than the number of gradations of the LCD 20 with which the DSC 1 is disposed.

Next, the primary image data generating module 31 subtracts 128, i.e., the lower limit of the first gradation range, from the gradation value of each pixel. Thus, the Y component is represented by a gradation range of 0 to 255, so that the number of gradations thereof becomes 256. The primary image data generating module 31 executes processing for compressing 512 gradations to 256 gradations in regard to the Cb component and the Cr component. When the gradation values of the Y component of the generated primary image data are graphed, they appear as in graph 43 of FIG. 1. Because the number of gradations of the primary image data becomes 256 gradations, which is smaller than the number of gradations of the original image data, the subject represented by the primary image data can be displayed, by displaying the primary image data, even on the LCD 20, whose number of reproducible gradations is only 256.

The secondary image data generating module 32 is a module for executing processing for generating secondary image data. The secondary image data generating module 32 generates, on the basis of the original image data outputted from the digital image processing unit 14, secondary image data that supplement the primary image data when the original image data are regenerated. Specifically, the secondary image data generating module 32 is a module for generating, on the basis of the original image data, secondary image data having gradation values in a linear relationship with the gradation values of the original image data outside the first gradation range.

Graphs 42 and 44 in FIG. 1 show the gradation values of the Y component of pixels configuring the secondary image data. The secondary image data are information representing gradation values having a linear relationship with the gradation values of the original image data outside the first gradation range. Assuming that the first gradation range is 128 to 384 as described above, the gradation ranges of 0 to 127 and 385 to 511 (second gradation ranges) of the primary image data are converted to gradation values of secondary image data in a linear relationship. In this case, secondary image data are generated in regard to the two second gradation ranges. It will be noted that the second gradation ranges may include gradation ranges further outside the first gradation range, i.e., may include gradation ranges corresponding to light quantity ranges whose gradations are saturated by the primary image data; alternatively, the second gradation ranges and the first gradation range may partially overlap.

Specifically, for example, the secondary image data generating module 32 generates secondary image data representing gradation values having a linear relationship with the gradation values of the original image data outside the first gradation range as follows. When the secondary image data generating module 32 generates secondary image data in regard to the gradation range of 385 to 511 of the primary image data, the secondary image data generating module 32 substitutes 385 for gradation values less than 385 of the gradation values configuring the original image data. The secondary image data generating module 32 retains, as is, gradation values exceeding 385. Next, the secondary image data generating module 32 subtracts 385 from the gradation value of each pixel. Namely, the secondary image data generating module 32 subtracts the lower limit of this second gradation range. When the lower limit of this second gradation range is subtracted from each gradation value, the differences between the gradation value of each pixel and the lower limit of this second gradation range become the gradation values of the secondary image data in regard to this second gradation range of the primary image data. When the differences are used as the gradation values of the secondary image data, the data amount of the secondary image data can be reduced in regard to a case where the number of gradations of the original image data is used as the number of gradations of the secondary image data. If it is unnecessary to reduce the data amount, there is no need to subtract the lower limit. Next, the secondary image data generating unit 32 determines the lowest number of bits necessary to express the maximum gradation value of the secondary image data, and stores each gradation value with the determined number of bits.

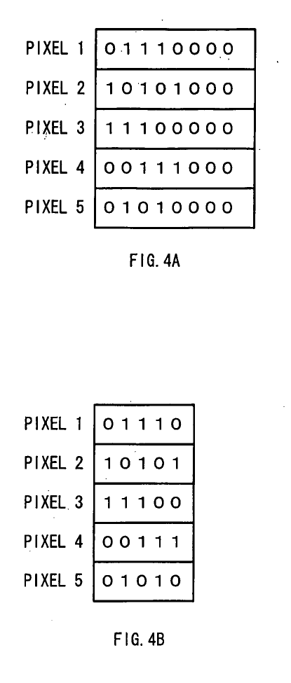

FIGS. 4A and 4B are schematic diagrams for describing the processing for determining the lowest number of bits necessary for expressing the maximum gradation value of the secondary image data. FIG. 4A shows, in 8 bits, the gradation values of pixels configuring the secondary image data. As will be understood from FIG. 4A, the gradation values of the pixels configuring the secondary image data can be expressed by a maximum of 5 bits from the left. Thus, by expressing the secondary image data with 5 bits per pixel, 3 bits of information can be reduced per pixel, whereby the data amount of the secondary image data can be reduced. As shown in FIG. 4B, the secondary image data generating module 32 compresses the secondary image data so that each pixel is expressed with 5 bits. The same is true of the secondary image data generated in regard to the range of 0 to 127.

When the gradation values of the Y component of the generated secondary image data are graphed, they appear as in graphs 42 and 44 of FIG. 1. For the purpose of relieving the failure to adjust the exposure, it suffices as long as there is the Y component (luminance component) in regard to the secondary image data. For this reason, the secondary image data generating module 32 stores only the Y component without executing processing in regard to the Cb component and the Cr component. Because only the Y component is stored, the data amount can be further reduced in regard to the secondary image data.

The image data saving module 33 is a module for executing processing for storing the generated primary image data and secondary image data in the removable memory 16. The image data saving module 33 saves the primary image data and the secondary image data in a single file and stores the file in the removable memory 16. When the primary image data and the secondary image data are saved in a single file, it becomes easy to mutually associate and handle the primary image data and the secondary image data.

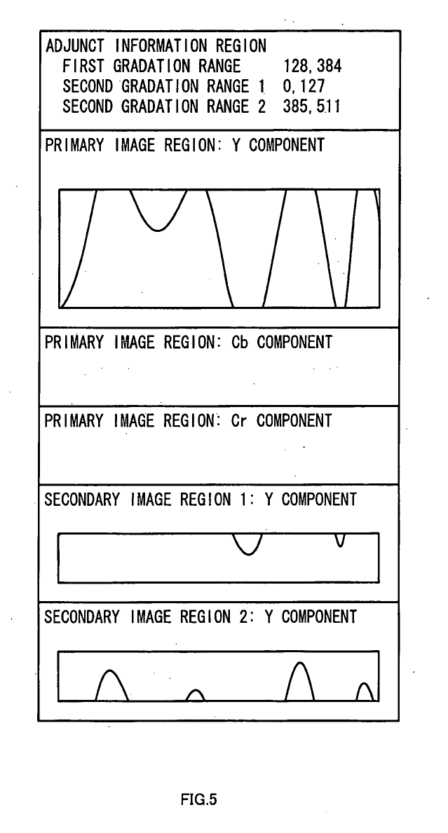

FIG. 5 is a schematic diagram showing the file structure of the file in which the primary image data and the secondary image data are saved. The graphs in FIG. 5 are shown for convenience so that the image data saved in those regions will be clear. The file in which the primary image data and the secondary image data are saved is configured by an adjunct information region, primary image data regions, a secondary image data region 1 and a secondary image data region 2. The adjunct information region is a region in which adjunct information in regard to the file is saved. In the present embodiment, the first gradation range and the second gradation ranges are saved as the adjunct information. The first gradation range is defined by the lower limit and the upper limit of the first gradation range. In the case of the previously described example, “128, 384” is saved as the first gradation range. The same is true in regard to the second gradation ranges. The primary image data regions are regions in which the primary image data are saved. The Y component, the Cb component and the Cr component are saved in the primary image data regions. It will be noted that graphs in regard to the Cb component and the Cr component are omitted from FIG. 5. The secondary image data regions are regions in which the secondary image data are saved. Only the Y component of the secondary image data is saved in the secondary image data regions because only the Y component serves as the secondary image data. It will be noted that the primary image data and the secondary image data may also be saved in different files.

The image data saving module 33 does not invariably always store secondary image data. When the secondary image data are empty, the image data saving module 33 does not store the secondary image data. By “when the secondary image data are empty” is meant when the gradation values of the secondary image data are all zero. For example, in the case of overexposure, sometimes there are no gradation values in the gradation range of 0 to 127 in the original image data. In this case, all the gradation values of the secondary image data corresponding to the second gradation range of 0 to 127 become zero. In this case, the image data saving module 33 does not save the secondary image data because doing so would be pointless, but does save only the secondary image data corresponding to the second gradation range of 383 to 511.

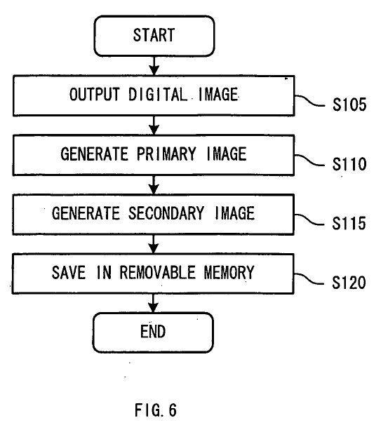

FIG. 6 is a flow chart showing the flow of processing for generating the primary image data and the secondary image data.

In S105, a subject is shot and original image data representing that subject are outputted.

In S110, primary image data are generated from the original image data.

In S115, secondary image data are generated from the original image data.

In S120, the generated primary image data and secondary image data are saved in a single file and stored in the removable memory 16.

Thus, the primary image data and the secondary image data are stored.

Next, the logical configuration of the image data reproducing program will be described.

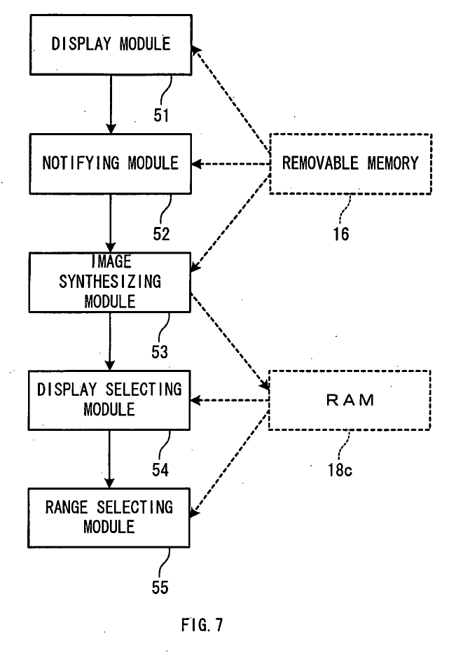

FIG. 7 is a block diagram showing the logical configuration of the image data reproducing program. The image data reproducing program is disposed with a display module 51, a notifying module 52, an image data synthesizing module 52, a display selecting module 54 and a range selecting module 55.

The notifying module 52 is a module for executing processing for notifying the user that underexposure or overexposure can be compensated. When the secondary image data are stored in the file, the notifying module 52 reads the information representing the first gradation range and the information representing the second gradation ranges from the file, and compares the second gradation ranges corresponding to the secondary image data with the first gradation range corresponding to the primary image data. When the second gradation ranges are brighter than the first gradation range, the notifying module 52 displays, on the LCD 20, a dialog notifying the user that the overexposure can be compensated. Conversely, when the second gradation ranges are darker than the first gradation range, the notifying module 52 displays, on the LCD 20, a dialog notifying the user that the underexposure can be compensated.

FIG. 8 is a schematic diagram showing a dialog 61 notifying the user that overexposure can be compensated. Thus, the user can be made aware that the original image data are relievable, and a situation can be prevented where the user gives up without knowing that the original image data are relievable. The same is true in the case of underexposure.

The image data synthesizing unit 53 is a module for executing processing for synthesizing the primary image data and the secondary image data. When the primary image data and the secondary image data are synthesized, the original image data serving as the source of the primary image data and the secondary image data are restored. The image data obtained by synthesizing the primary image data and the secondary image data, and which are the same as the original image data, will be referred to as composite image data. When the primary image data and the secondary image data are to be synthesized, it is necessary to identify which of the plural sets of secondary image data is a higher exposure than that of the primary image data and which is a lower exposure than that of the primary image data. This identification becomes possible by using the information representing the first gradation range and the information representing the second gradation ranges stored as the adjunct information in the file. Because the processing for synthesizing the primary image data and the secondary image data is substantially the reverse of the processing for generating the primary image data and the secondary image data, detailed description thereof will be omitted.

The display selecting module 54 is a module for executing processing for handling the selection of the method of displaying the composite image data. The display selecting module 54 displays a dialog for handling the selection of whether to extend or compress the gradation values of the composite image data or to select a gradation range. When extension or compression is selected in the dialog, the display selecting module 54 instructs the display module 51 to extend or compress the gradation values and display the composite image data, and when gradation range selection is selected, the display selecting module 54 calls up the range selecting module 55.

The range selecting module 55 is a module for executing processing for handling the selection, from the gradation ranges of the composite image data, the gradation range to be reproduced in the image data reproducing device.

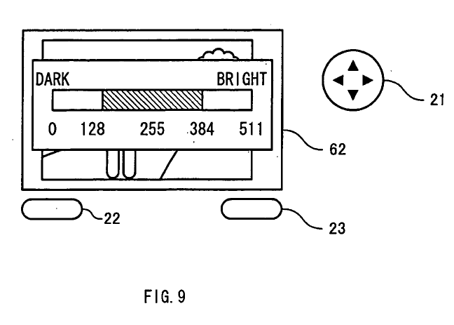

FIG. 9 is a schematic diagram showing an example of a dialog 62 displayed by the range selecting module 55. A slider bar for selecting the gradation range is displayed in the dialog 62. The length of the slider bar corresponds to the number of gradations reproducible by the LCD 20, and the range over which the slider bar is movable corresponds to the gradation range of the composite image data serving as the reproduction target at that time. For example, assuming that the number of gradations reproducible by the LCD 20 is 256 and that the gradation range of the composite image data is 0 to 511, the ratio between the length of the slider bar and the range over which the slider bar is movable becomes 256:512. The user can shift, by one gradation, the slider bar in the direction where exposure is low by depressing the left end of the arrow key 21 once; conversely, the user can shift, by one gradation, the slider bar in the direction of high exposure by depressing the right end of the arrow key 21. The display module 51 is called up each time the slider bar is shifted.

It will be noted that the invention may also be configured so that the gradation range is selected by selecting the light quantity range of the EV scale rather than directly selecting the gradation range, because the gradation range can also be clearly specified from the light quantity range of the EV scale. Because the DSC 1 relieves failed imaging resulting from failure to adjust the exposure, a more intuitive compensation is possible by configuring the invention so that the gradation range can be indirectly selected with the EV scale.

The display module 51 is a module for displaying the primary image data or the composite image data. When the image data reproducing program is executed, the display module 51 is initially called up to display the primary image data. When the display module 51 is instructed by the display selecting module 54 to extend or compress the image data, the display module 51 converts, in accordance with a predetermined standard, the gradation values of the composite image data so that they are within the range of the number of gradations of the LCD 20. As a result, the composite image data are subjected to color reduction or color increase in accordance with the number of gradations of the LCD 20, and the composite image data are reproduced. When the display module 51 is called up by the range selecting module 55, the display module 51 converts the composite image data in accordance with the gradation range selected by the range selecting module 55 and reproduces the converted composite image data.

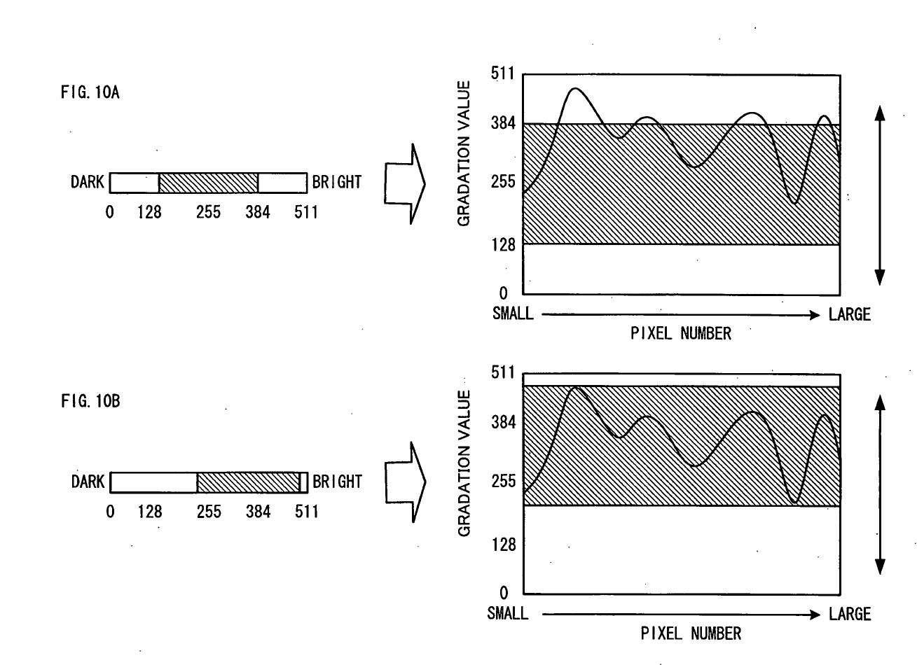

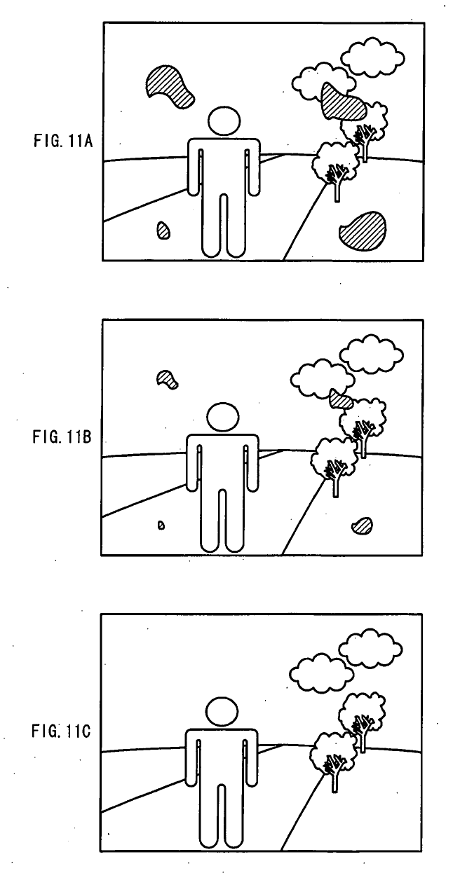

FIGS. 10A and 10B are schematic diagrams showing the relationship between the gradation range selected by the range selecting module 55 and the gradation values of the composite image data. FIGS. 11A to 11C are schematic diagrams for describing a case where failure is relieved as a result of an appropriate gradation range being selected by the range selecting module 55.

For example, let us assume that the presently selected gradation range is 128 to 384. When a gradation range of a range x gradations higher is selected, in regard to pixels of the composite image data whose gradation value exceeds 384+x, the gradation values of those pixels are set to 384+x. In regard to pixels of the composite image data whose gradation values are less than 128+x, the gradation values of those pixels are set to 128+x. Next, after 128+x is subtracted from all of the gradation values of the composite image data, the composite image data expressed by gradation values of 0 to 255 are displayed on the LCD 20. As a result, the composite image data are displayed in accordance with the selected gradation range.

For example, when black saturation has occurred in places due to underexposure as shown in FIG. 11A, the black saturation is gradually reduced as shown in FIG. 11B as the selected gradation range becomes lower. By repeatedly adjusting the gradation range, high-quality image data, where the underexposure has been relieved, are obtained as shown in FIG. 1C. The user can finely select how to relieve the image data by appropriately shifting the gradation range as desired.

Next, the flow of processing for displaying the primary image data or the composite image data will be described.

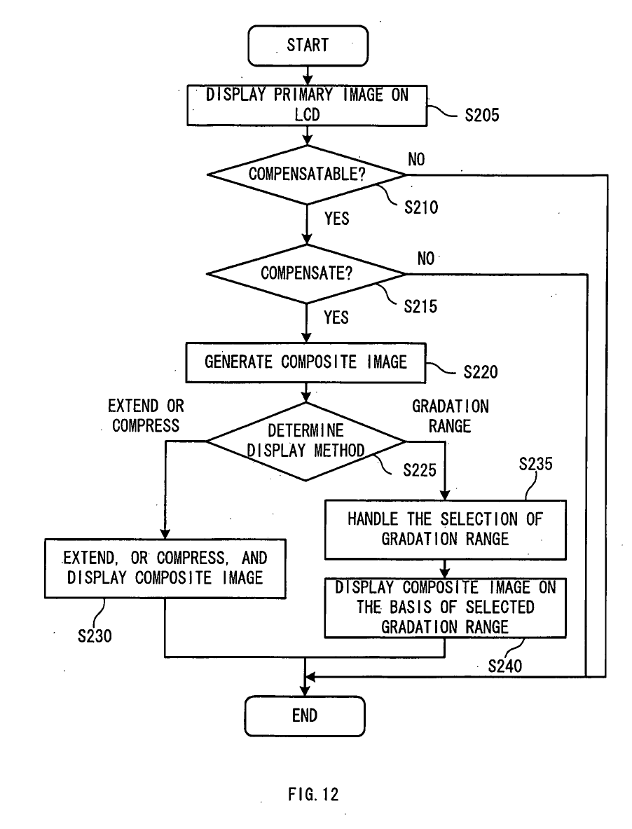

FIG. 12 is a flow chart showing the flow of processing by which the DCS 1 displays the primary image data or the composite image data.

In S205, first, the primary image data are displayed on the LCD 20.

In S210, the information representing the first gradation range and the information representing the second gradation ranges are read from the file, and whether or not exposure compensation is possible is determined. When it is determined that exposure compensation is possible, the processing proceeds to S215.

In S215, the dialog 61 is displayed, and the processing proceeds to S220 when execution of compensation is selected.

In S220, the DSC 1 synthesizes the primary image data and the secondary image data to generate the composite image data.

In S225, a dialog is displayed, and the selection of whether the gradation values of the composite image data are to be extended or compressed, or whether a gradation range is to be selected, is handled. When extension or compression is selected, the processing proceeds to S230, and when gradation range selection is selected, the processing proceeds to S235.

In S230, the composite image data are extended or compressed and displayed.

In S235, the dialog 62 is displayed and selection of the gradation range of the reproduction target is handled.

In S240, the composite image data are displayed in accordance with the selected gradation range.

According to the DSC 1 pertaining to the first embodiment of the invention described above, primary image data of a number of gradations smaller than that of the outputted original image data are generated. Thus, the primary image data can be played back even on the LCD 20 whose number of reproducible gradations is small. Also, because the number of gradations per component that a PC can display is usually 256, when the image data are to distributed to an acquaintance having such a PC, the primary image data are distributed rather than the outputted original image data being distributed, whereby even the acquaintance to whom the primary image data were distributed can reproduce the image data. Also, because the DSC 1 records, together with the primary image data, the secondary image data representing the subject in regard to the light quantity range saturated by the primary image data, it becomes possible to supplement, with the secondary image data, places in the primary image data where white saturation and black saturation have occurred.

It will be noted that, in the first embodiment, although an example was described where the image data reproducing system was configured only by the DSC 1, the image data reproducing system may also be configured by the DSC 1 and a personal computer (PC), and a display with which the PC is disposed may be used as the image data reproducing device.

### Second Embodiment

The second embodiment is an example where the original image data are reproduced by printing. In the second embodiment, the same reference numerals will be given to portions that are substantially the same as those in the first embodiment, and description of those portions will be omitted.

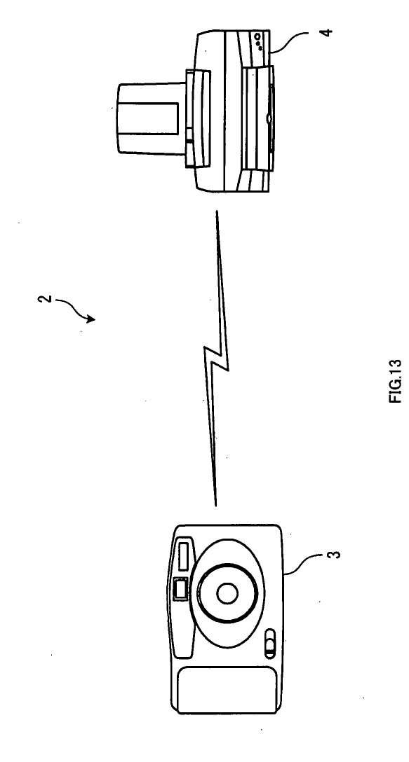

FIG. 13 is a schematic diagram showing an image data reproducing system 2 pertaining to the second embodiment. The image data reproducing system 2 is configured by a DSC 3 serving as an imaging device and a printer 4 serving as an image data reproducing device. The DSC 3 and the printer 4 are communicably interconnected. The printer 4 can print original image data at a number of gradations equal to or greater than the number of gradations of the original image data generated by the DSC 3.

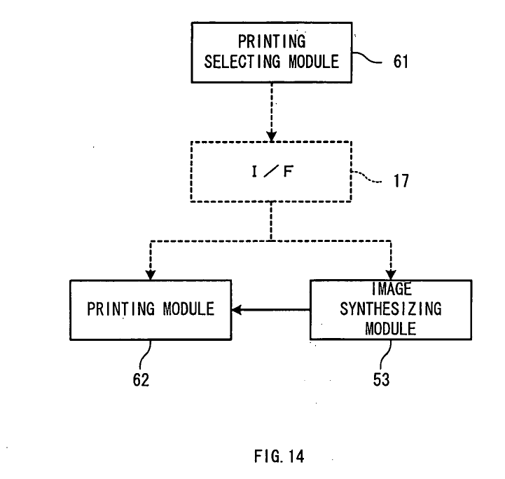

FIG. 14 is a block diagram showing the logical configuration of an image data reproducing program. The image data reproducing program is disposed with a printing selecting module 61, the image data synthesizing module 53 and a printing module 62.

The printing selecting module 61 is a module that handles the selection of whether to print the primary image data or the composite image data. The printing selecting module 61 is a module that is executed by the DSC 3, displays a screen for handling the selection of the printing target image data file and a screen for handling the selection of whether to print the primary image data or the composite image data in regard to the selected printing target image data file, and instructs the printer 4 to print the image data in accordance with the selection made by the user.

The printing module 62 is a module for executing processing for printing the primary image data when printing of the primary image data has been selected, and for printing the composite image data when printing of the composite image data has been selected.

Next, the flow of the processing for printing the primary image data or the composite image data will be described.

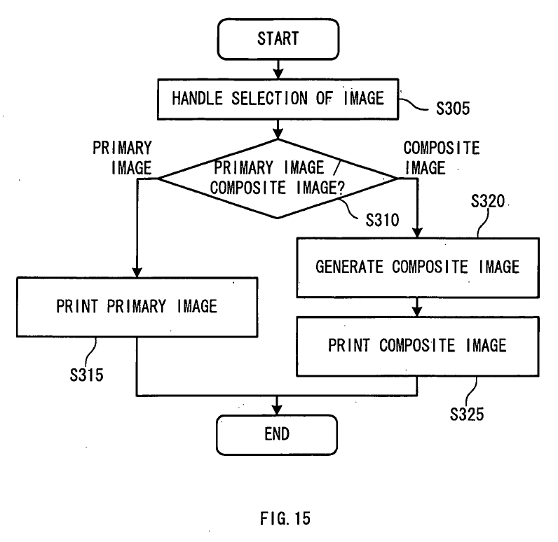

FIG. 15 is a flow chart showing the flow of the processing for printing the primary image data or the composite image data.

In S305, the selection of the image data to be printed is handled.

In S310, the selection of whether to print the primary image data or the composite image data is handled. When printing of the primary image data is selected, the processing proceeds to S315, and when printing of the composite image data is selected, the processing proceeds to S320.

In S315, the primary image data are printed.

In S320, the primary image data and the secondary image data are synthesized to generate the composite image data.

In S325, the composite image data are printed.

It will be noted that the generation of the composite image data may also be conducted by the DSC 3. Also, the system may be configured so that the gradation range of the printing target can be selected with respect to the generated composite image data. Conversely, the system may also be configured so that the selection of the image data and the selection of whether to print the primary image data or the composite image data can be conducted with the printer 4.

### Third Embodiment

The DSC of the third embodiment conducts shooting several times under mutually different exposure conditions when the shutter button is depressed once, to thereby generate plural sets of image data representing the same subject. For example, in the second shooting, the exposure condition is changed +1 EV from the first shooting, and in the third shooting, the exposure condition is changed −1 EV from the first shooting.

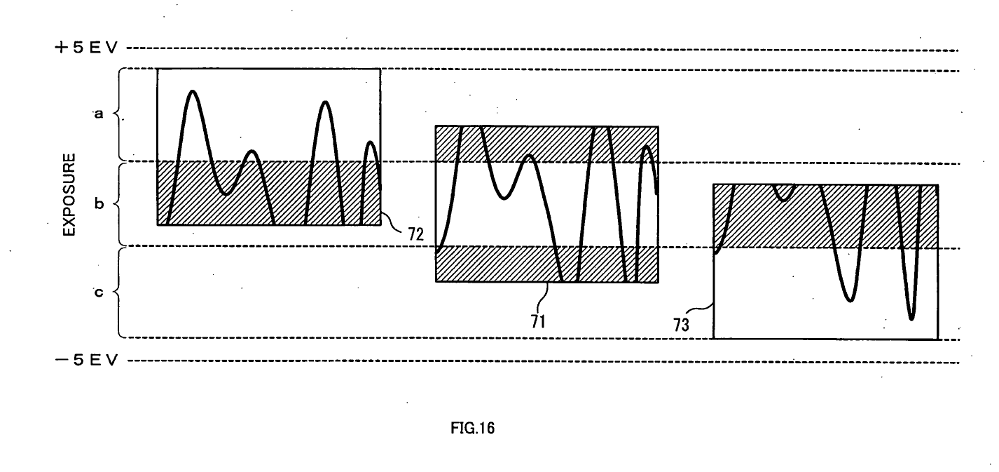

FIG. 16 is a schematic diagram for describing the gradation values of the plural sets of image data that represent the same subject and are generated in this manner. When the contrast of the subject is high with respect to the latitude of the image sensor 12, sometimes the gradations of the subject cannot be expressed with one set of image data. For example, in the set of image data 71 in FIG. 16, the gradation values are saturated in both the bright region and the dark region. In the set of image data 72 generated under the +1 EV shooting condition with respect to the set of image data 71, the gradations of the bright region that cannot be expressed by the set of image data 71 are expressed. And in the set of image data 73 generated under the −1 EV shooting condition with respect to the set of image data 71, the gradations of the dark region that cannot be expressed by the set of image data 71 are expressed. Thus, by combining the set of original image data 72 and the set of original image data 73 with the set of original image data 71, failed shooting can be relieved.

Next, the generation of the primary image data and the secondary image data will be described. The DSC generates the primary image data on the basis of the set of image data 71 shot at a standard exposure, for example. Specifically, the DSC generates the primary image data using, as the first gradation range, the gradation range corresponding to the light quantity range b of the set of image data 71. Next, the DSC generates the secondary image data on the basis of the set of image data 72 generated under the +1 EV shooting condition and the set of image data 73 generated under the −1 EV shooting condition. The light quantity ranges in which the gradations of the set of image data 72 and the set of image data 73 are expressed partially overlap the set of image data 71. Thus, the DSC determines the gradation values of the sets of image data 72 and 73 corresponding to the upper limit and lower limit of the light quantity region b, uses the determined gradation values as the upper limit and lower limit of the second gradation ranges described in the first embodiment, and generates, in the same manner as in the first embodiment, secondary image data expressing gradation values equal to or less than the upper limit or secondary image data expressing gradation values equal to or greater than the lower limit. As a result, secondary image data corresponding to the light quantity region a and secondary image data corresponding to the light quantity region c are generated. It will be noted that the DSC may also be configured to store, as is, the set of image data 72 and the set of image data 73 as the secondary image data. In this case, the composite image data are generated using the gradation values corresponding to the light quantity region a or the light quantity region c.

1. An imaging method comprising the steps of:
imaging a subject at a specific latitude to generate original image data of a first number of gradations;
generating, on the basis of the original image data, primary image data representing the subject at a second number of gradations fewer than the first number of gradations in regard to a first light quantity range narrower than the latitude;
generating, on the basis of the original image data, secondary image data representing the subject in regard to a second light quantity range including a light quantity range where the gradations are saturated by the primary image data; and
associating and saving the primary image data and the secondary image data.

2. An imaging method comprising the steps of:
imaging a subject plural times at mutually different latitudes in accordance with a one-time imaging instruction to generate plural sets of original image data of a first number of gradations;
generating, on the basis of one of the plural sets of original image data outputted by the imaging step, primary image data representing the subject in regard to a first light quantity range;
generating, on the basis of another one of the plural sets of original image data, secondary image data representing the subject in regard to a second light quantity range including a light quantity range where the gradations are saturated by the primary image data; and
associating and saving the primary image data and the secondary image data.

3. The imaging method of claim 1 or 2, wherein in the saving step, the primary image data and the secondary image data are saved in different regions of a same file.

4. The imaging method of claim 1 or 2, wherein in the step of generating the secondary image data, the lowest number of bits necessary for expressing the maximum gradation value of the secondary image data is determined, and the gradation values of the secondary image data are expressed by the determined number of bits.

5. The imaging method of claim 1 or 2, wherein
in the step of generating the primary image data, the generated primary image data have gradation values of a luminance component and a color difference component per pixel, and
in the step of generating the secondary image data, the generated secondary image data have gradation values of only a luminance component per pixel.

6. The imaging method of claim 1 or 2, wherein in the saving step, information representing the first light quantity range is associated and stored with the primary image data, and information representing the second light quantity range is associated and stored with the secondary image data.

7. The imaging method of claim 1 or 2, wherein in the saving step, the secondary image data are stored only when there are pixels where the gradations are saturated by the primary image data.

8. An imaging device comprising:
an imaging unit for imaging a subject at a specific latitude to generate original image data of a first number of gradations;
a primary image data generating unit for generating, on the basis of the original image data, primary image data representing the subject at a second number of gradations fewer than the first number of gradations in regard to a first light quantity range narrower than the latitude;
a secondary image data generating unit for generating, on the basis of the original image data, secondary image data representing the subject in regard to a second light quantity range including a light quantity range where the gradations are saturated by the primary image data; and
a saving unit for associating and saving the primary image data and the secondary image data.

9. A computer-readable storage medium in which is stored a program causing a digital camera to function as:
an imaging unit for imaging a subject at a specific latitude to generate original image data of a first number of gradations;
a primary image data generating unit for generating, on the basis of the original image data, primary image data representing the subject at a second number of gradations fewer than the first number of gradations in regard to a first light quantity range narrower than the latitude;
a secondary image data generating unit for generating, on the basis of the original image data, secondary image data representing the subject in regard to a second light quantity range including a light quantity range where the gradations are saturated by the primary image data; and
a saving unit for associating and saving the primary image data and the secondary image data.

10. An imaging device comprising:
an imaging unit for imaging a subject plural times at mutually different latitudes in accordance with a one-time imaging instruction to generate plural sets of original image data of a first number of gradations;
a primary image data generating unit for generating, on the basis of one of the plural sets of original image data outputted from the imaging unit, primary image data representing the subject in regard to a first light quantity range;
a secondary image data generating unit for generating, on the basis of another one of the plural sets of original image data, secondary image data representing the subject in regard to a second light quantity range including a light quantity range where the gradations are saturated by the primary image data; and
a saving unit for associating and saving the primary image data and the secondary image data.

11. A computer-readable storage medium in which is stored a program for causing a digital camera to function as:
an imaging unit for imaging a subject plural times at mutually different latitudes in accordance with a one-time imaging instruction to generate plural sets of original image data of a first number of gradations;
a primary image data generating unit for generating, on the basis of one of the plural sets of original image data outputted from the imaging unit, primary image data representing the subject in regard to a first light quantity range;
a secondary image data generating unit for generating, on the basis of another one of the plural sets of original image data, secondary image data representing the subject in regard to a second light quantity range including a light quantity range where the gradations are saturated by the primary image data; and
a saving unit for associating and saving the primary image data and the secondary image data.

12. An image reproducing method comprising the steps of:
synthesizing primary image data representing a subject in regard to a first light quantity range and secondary image data representing the subject in regard to a second light quantity range including a light quantity range where the gradations are saturated by the primary image data, to thereby generate composite image data representing the subject in regard to a light quantity range including the first light quantity range and the second light quantity range; and
reproducing the composite image data.

13. The image reproducing method of claim 12, further comprising the step of handling the selection of the primary image data or the composite image data, wherein in the reproducing step, one of the composite image data and the primary image data selected in the selection handling step is reproduced.

14. The image reproducing method of claim 12, further comprising the step of selecting a gradation range of the composite image data, wherein in the reproducing step, the composite image data are reproduced in regard to the gradation range selected in the gradation range selecting step.

15. The image reproducing method of claim 12, wherein in the reproducing step, the gradation values of the composite image data are extended or compressed in accordance with the number of reproducible gradations.

16. The image reproducing method of claim 12, further comprising the step of notifying a user that underexposure or overexposure can be compensated on the basis of the secondary image data.

17. An image reproducing device comprising:
an image data synthesizing unit for synthesizing primary image data representing a subject in regard to a first light quantity range and secondary image data representing the subject in regard to a second light quantity range including a light quantity range where the gradations are saturated by the primary image data, to thereby generate composite image data representing the subject in regard to a light quantity range including the first light quantity range and the second light quantity range; and
a reproducing unit for reproducing the composite image data.

18. A computer-readable storage medium in which is stored a program for causing a computer to act as:
an image data synthesizing unit for synthesizing primary image data representing a subject in regard to a first light quantity range and secondary image data representing the subject in regard to a second light quantity range including a light quantity range whose gradations are saturated by the primary image data, to thereby generate composite image data representing the subject in regard to a light quantity range including the first light quantity range and the second light quantity range; and
a reproducing unit for reproducing the composite image data.

19. An image processing method comprising the steps of:
imaging a subject at a specific latitude with an imaging unit to generate original image data of a first number of gradations;
generating, on the basis of the original image data, primary image data representing the subject at a second number of gradations fewer than the first number of gradations in regard to a first light quantity range narrower than the latitude;
generating, on the basis of the original image data, secondary image data representing the subject in regard to a second light quantity range including a light quantity range where the gradations are saturated by the primary image data;
associating and saving the primary image data and the secondary image data;
synthesizing the primary image data and the secondary image data to thereby generate composite image data representing the subject in regard to a light quantity range including the first light quantity range and the second light quantity range; and
reproducing the composite image data.

20. An image processing method comprising the steps of:
imaging a subject plural times at mutually different latitudes in accordance with a one-time imaging instruction to generate plural sets of original image data of a first number of gradations;
generating, on the basis of one of the plural sets of original image data outputted by the imaging step, primary image data representing the subject in regard to a first light quantity range;
generating, on the basis of another one of the plural sets of original image data, secondary image data representing the subject in regard to a second light quantity range including a light quantity range where the gradations are saturated by the primary image data;
associating and saving the primary image data and the secondary image data;
synthesizing the primary image data and the secondary image data to thereby generate composite image data representing the subject in regard to a light quantity range including the first light quantity range and the second light quantity range; and
reproducing the composite image data.
